(19) United States
(12) Patent Application Publication
(10) Pub. No.: US 2018/0316901 A1
(43) Pub. Date: Nov. 1, 2018

(54) EVENT RECONSTRUCT THROUGH IMAGE REPORTING

(71) Applicant: Ford Global Technologies, LLC, Dearborn, MI (US)

(72) Inventors: Leonard E. Carrier, Dearborn, MI (US); Seok Lee, Canton, MI (US)

(21) Appl. No.: 15/497,599

(22) Filed: Apr. 26, 2017

(51) Int. Cl. H04N 13/02; H04L 29/08; G06K 9/00; G01S 19/05

(52) U.S. Cl. CPC H04N 13/026; H04L 67/12; H04W 4/008; G06K 9/00805; G01S 19/05; H04N 13/0242

(57) ABSTRACT

A method of scene reconstruction including detecting an occurrence of a reportable event. A message is broadcast identifying the reportable event to remote entities. 2-D images are captured by cameras mounted on the remote entities in a vicinity of the reportable event. The captured images transmitted from the remote entities to a central entity. A 3-D scene of the reportable event is generated, by the central entity, based on the captured images by the remote entities.

### CROSS REFERENCE TO RELATED APPLICATIONS

Not Applicable.

### STATEMENT REGARDING FEDERALLY SPONSORED RESEARCH

Not Applicable.

### BACKGROUND OF INVENTION

The present invention relates generally scene reconstruction through image capture.

Digital imaging allows users to easily capture a plurality of images of a scene. Image capture devices through memory storage allow the user to capture the plurality of images and later determine which images are relevant and which are not. The user is limited by its viewing perspective of the scene and an allocated amount of time that a user can capture an image. For example, if a user is attempting to capture a dynamic scene, the user is limited by the time that the scene is dynamic and the viewing perspective of the image capture device. Alternatively, if a user is capturing stationary scene while the user is dynamic (e.g., passing by in a car), the user again is limited by its viewing perspective along it path of travel and the viewing time while it is in the vicinity of the scene that it is capturing.

Therefore, when capturing a reportable event, a user for example approaching a scene (e.g., accident) may be beneficial to capture an image in the event some entity desires to utilizing information from the scene to recreate the scene. However, the user is limited by short amount of time that the user may have to capture one or more images as it passes the scene. The viewing perspective of the user from the path of travel further limits the user. In addition, the user may not be able to capture an image due to its focus on the road of travel. As a result, the opportunity to capture and provide details of the scene may be limited due to various factors even when a plurality of images is captured by the user.

### SUMMARY OF INVENTION

In one aspect of the invention, a system cooperatively obtains a plurality of 2-dimensional images of a reportable event at different viewing perspectives. The system collectively generates a 3-dimensional scene of the reportable event based on the 2-dimensional images captured at different viewing perspectives. An occurrence of the reportable event is broadcast to remote entities identifying a location of the event. Remote entities in a vicinity of the event captures images of the event using vehicle mounted cameras at the different viewing perspectives. The captured images are transmitted to a central entity for generating the 3-dimensional scene. The 3-dimensional scene may be used by various entities to understand the current situation of the event to access whether emergency dispatch is required or for later analyzing what caused the incident as well as the extent of damage resulting from the incident.

The system as described herein allows the use of various images captured at different instances of time as well as different viewing perspectives to cooperatively re-create a 3-dimensional scene of the event for analysis. Generating the 3-dimensional scene provides greater details than can be obtained from a 2-dimensional image. In addition, since the broadcast of the message, image capture, and transmittance of the message are performed autonomously, a driver is not distracted in having to capture the images at the event and may rely on the system to autonomously capture the event and relay such information to a distribution entity.

Termination of the image capture request is performed by a central entity analyzing the received data to determine whether a sufficient amount of images are captured for reconstructing the scene. Alternatively, termination may be based on a duration of time as well as predetermined number of images being captured.

An embodiment contemplates a method of scene reconstruction including detecting an occurrence of a reportable event. A message is broadcast identifying the reportable event to remote entities. 2-dimensional images are captured by cameras mounted on the remote entities in a vicinity of the reportable event. The captured images are transmitted from the remote entities to a central entity. A 3-dimensional scene of the reportable event is generated, by the central entity based on the captured images by the remote entities.

An embodiment contemplates a scene reconstruction system including a plurality of remote entities capturing images of a reportable event from various viewing perspectives. A central entity generates a 3-dimensional scene of the reportable event based on the captured images. A communication system broadcasts messages to remote entities identifying the reportable event, and requests capturing images of the reportable event. A distribution entity receives the generated 3-dimensional scene and performing investigation operations of the event.

### BRIEF DESCRIPTION OF DRAWINGS

FIG. 1 is a block diagram of a cooperative imaging collection and scene reconstruction system.

FIG. 2 is a flowchart of a technique for recreating a 3-D scene of an event.

### DETAILED DESCRIPTION

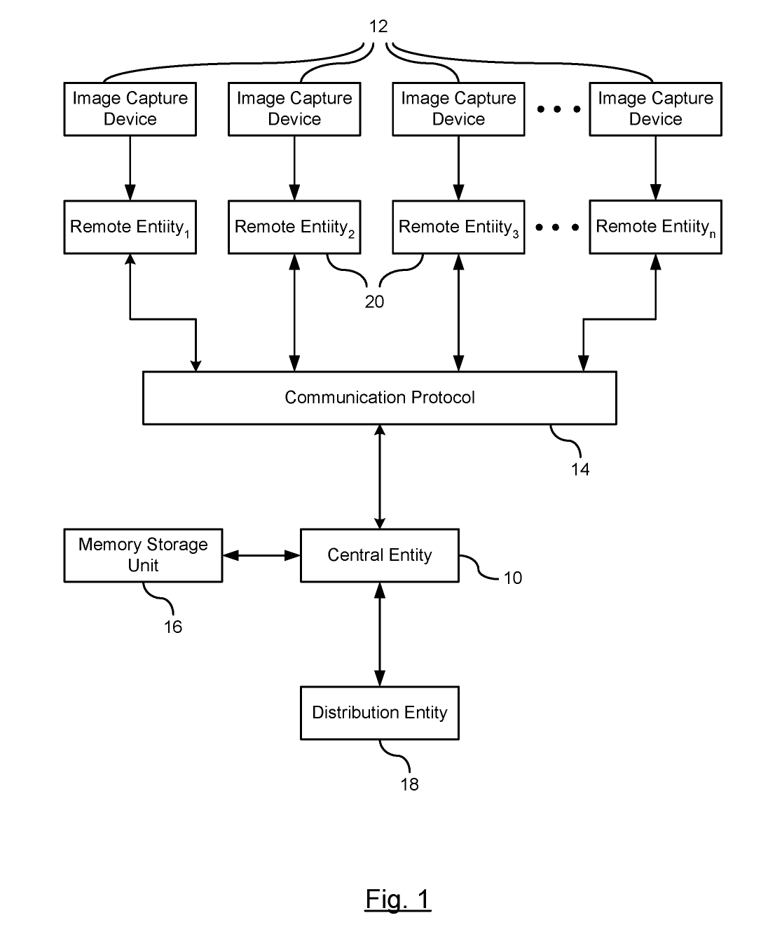

There is shown in FIG. 1 a block diagram of a cooperative imaging collection and scene reconstruction system. The system includes a central entity 10 that may include, but is not limited to, a server, roadside entity, cloud, or vehicle processing unit. The system may further include image capture devices 12, a V2X communication system 14, a memory storage device 16, and a distribution entity 18.

The image capture devices 12 are disposed on remote entities 20 and are activated in response to a notification or detection of an occurring event (e.g., accident, crime, etc.). The image capture devices 12 capture images of a scene of the event taken from the perspective of each respective image capture device. Each of the image capture devices 12 are mounted on the remote entities 20 that include, but are not limited to, vehicles, autonomous vehicles, motorcycles, roadside units, pedestrians, and bicycles. The images captured by the remote entities 20 are typically 2-dimensional (hereinafter referred to as 2-D) images. The system cooperatively collects various images taken from various camera poses (e.g., viewing perspective) to collectively recreate a scene in 3-dimensions (hereinafter referred to as 3-D) which assist in explaining the cause of the events results of the events, or people that may have been involved in the events. By utilizing remote entities 20 passing the scene, the event is captured at various viewing perspectives, and when taken collectively, the collective images provide a 3-D scene of the event.

The V2X communication system 14 is used to communicate between the various entities. The V2X communication system 14 may include, but is not limited to, vehicle-to-vehicle communications (V2V), vehicle to infrastructure (V2I), and vehicle to pedestrian (V2P). V2V communications may utilize, for example, Dedicated Short Range Communications (DSRC), which is a two-way short-to-medium-range wireless communications that permits very high data transmission in communications-based active safety applications for alerting surrounding vehicles and entities of the event.

Once the event is identified, the entity detecting the event can communicate a location of the event utilizing GPS coordinates obtained by an on-vehicle GPS system to other surrounding remote entities. As each remote entity passes the location of the event, images can be captured of the event at different viewing perspectives. It should be understood that the notification to surrounding entities is performed autonomously so that a driver of a vehicle is not distracted by the event in having to capture images manually themselves. Rather, each entity autonomously captures images while at the scene of the event based on the transmitted GPS location. As a result, the driver of a vehicle can focus on the road of travel while the imaging system captures one or more images of the scene.

The images captured by each remote entity are communicated to the central entity 10 for processing. The central entity 10 may include a server system, a dedicated vehicle, or a cloud for processing the image data. The central entity 10 may utilize the memory storage device 16 if additional memory is needed to store the image data.

The central entity 10 generates a 3-D scene utilizing the 2-D images. When a confidence level reaches a threshold signifying that the collected images provide sufficient details of the event for generating the 3-D scene, the central entity 10 will communicate to the remote entities 20 that no additional images are required. Alternatively, other conditions can trigger termination of image capture including, but not limited to, a predetermined threshold limit on the number of images captured or a predetermined duration threshold. In response to the condition exceeding the threshold, the remote entities terminate taking images of the event. Once the 3-D scene is recreated, the scene will be stored in the memory or will be provided to a distribution entity 18. The distribution entity 18 may include, but is not limited to, police agencies, fire & ambulance units, hospitals, insurance companies, investigators, and drivers involved.

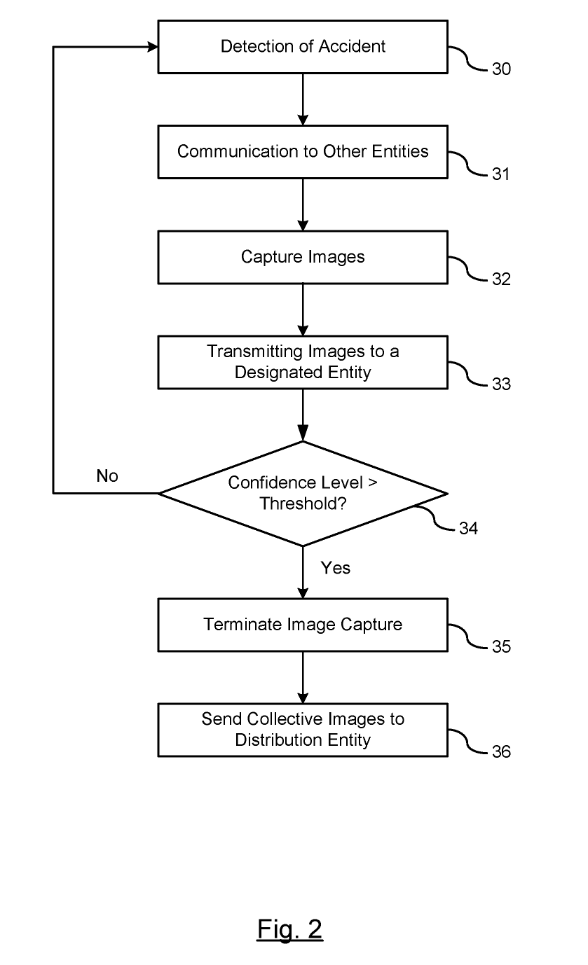

FIG. 2 illustrates a flowchart of a technique for recreating a 3-D scene of an event from the plurality of 2-D images captured by remote entities at various viewing angles.

In step 30, an event is detected that involves some activity where captured images of the event may be useful to one or more entities. Such events may include, but are not limited to, an accident or a crime scene. Detection of an event such as an accident includes a vehicle system or roadside unit capturing images of at least one stationary vehicle involved in the accident and/or detecting debris indicating an accident. Notification of an event may include detection by an observer and inputting an alert message into a messaging system, navigation system, social media system or similar. In order for the event not to be stale, there should be a stationary vehicle or other activity that would imply that the event or post transactions are still occurring.

In step 31, in response to detection of an event, an occurrence of the event is autonomously broadcast to other entities within the vicinity of the event. Such entities may include, but are not limited to, vehicles, roadside units, pedestrians, and bicycles. The communications may be broadcast using any V2X communication protocol. The communication signal further includes a location (e.g., GPS coordinate) of the event.

In step 32, in response to a notification of the event, remote entities at either the scene or approaching the scene will capture images of the event from various viewing perspectives. Roadside units fixed near the scene will capture images at a same viewing perspective. Other mobile entities passing the scene will capture images upon an approach of the scene as well as leaving the scene. Such images captured by the entities are 2-diminensional images. Utilizing various mobile and fixed entities, captured images at various viewing perspectives can collectively be used to generate a 3-D scene of the event.

In step 33, each of the images is transmitted to a designated entity. The designated entity determines when a sufficient amount images are captured for regenerating the 3-D scene.

In step 34, a determination is made as to whether a confidence level exceeds a threshold limit for determining whether enough images have been captured. Various determinations and respective thresholds may be used to determine whether the required amount of images is obtained. The designated entity may analyze each of the images and make a determination that the images, based on various criteria, collectively provide sufficient details to generate the 3-D image. The central entity may make the determination that the each of the images collectively provides sufficient amount of details, based on various viewpoints, to provide in-depth information about the event. Consequently, image stitching can be used to generate a substantially surround scene. The central entity may further determine that the scene is sufficiently captured based on the number of images collectively obtained by the various entities. The designated entity may further determine that the scene is sufficiently captured based on an elapsed duration of time since the notification was originally sent. The designated entity may further determine that the scene is sufficient captured if the no stationary entities remain at the scene indicating that those vehicles involved in the event are no longer located at the scene.

If the threshold limit is not exceeded, then the routine returns to step 30. If the threshold limit is exceeded, then the routine proceeds to step 35.

In step 35, the central entity communicates to the remote entities to terminate image capturing. Each of the remote entities may communicate this directive to other remote entities so that remote entities originally receiving the message are aware of the termination event.

In step 36, the central entity communicates to the distribution entity the regenerated 3-D scene of the event. The distribution entity may include, but is not limited to, police agencies, fire & ambulance units, hospitals, insurance companies, investigators, and involved drivers. The 3-dimensional image allows those analyzing the event to determine other characteristics about the event that may not be ascertainable from a typical 2-D image.

While certain embodiments of the present invention have been described in detail, those familiar with the art to which this invention relates will recognize various alternative designs and embodiments for practicing the invention as defined by the following claims.

What is claimed is:

1. A method of scene reconstruction comprising:
detecting an occurrence of a reportable event;
broadcasting a message identifying the reportable event to remote entities;
capturing 2-D images by cameras mounted on the remote entities in a vicinity of the reportable event;
transmitting the captured images from the remote entities to a central entity;
generating, by the central entity, a 3-D scene of the reportable event based on the captured images by the remote entities.

2. The method of claim 1 wherein detecting the occurrence of a reportable event includes detecting an accident along a road of travel.

3. The method of claim 1 wherein detecting the occurrence of the reportable event includes detecting a crime scene along a road of travel.

4. The method of claim 1 wherein a GPS position of the reportable event is included in the broadcast message to identify a location of the reportable event.

5. The method of claim 1 wherein the broadcast message to capture images is communicated through a V2X communication system.

6. The method of claim 1 wherein the central entity communicates the broadcast message to terminate image capture from the remote entities based on a determination that a comparative parameter exceeds a threshold limit.

7. The method of claim 1 wherein the central entity communicates the broadcast message to determine terminate image capture by the remote entities based on a determination that a sufficient amount of images are obtained to generate the 3-D scene.

8. The method of claim 1 wherein the central entity communicates the broadcast message to terminate image capture by the remote entities based on a determination that a predetermined number of images are captured.

9. The method of claim 1 wherein the central entity communicates the broadcast message to terminate image capture by the remote entities based on a determination that no stationary vehicles are present at the scene of the event.

10. The method of claim 1 wherein the central entity utilizes the 2-D images to image stitch a substantially surround view of the event.

11. The method of claim 1 wherein the central entity transmits the generated 3-D scene to a distribution entity to perform investigative operations of the event.

12. A scene reconstruction system comprising:
a plurality of remote entities capturing images of a reportable event from various viewing perspectives;
a central entity generating a 3-D scene of the reportable event based on the captured images;
a communication system broadcasting messages to remote entities identifying the reportable event and to request capturing images of the reportable event; and
a distribution entity receiving the generated 3-D scene and performing investigation operations of the event.

13. The scene reconstruction system of claim 12 wherein at least one of the remote entities detects an occurrence of the reportable event.

14. The scene reconstruction system of claim 12 wherein the reportable event is reported to the central entity, wherein the central entity broadcasts the message to remote entities to capture 2-D images of the reportable event to the remote entities.

15. The scene reconstruction system of claim 12 wherein the broadcast message includes a GPS position of the reportable event to identify a location of the reportable event.

16. The scene reconstruction system of claim 12 wherein the communication system includes a V2X communication system for broadcasting the broadcast message to capture images of the reportable event.

17. The scene reconstruction system of claim 12 wherein the central entity broadcasts the message to terminate image capture based on a determination that a comparative parameter exceeds a threshold limit.

18. The scene reconstruction system of claim 12 wherein the central entity broadcasts the message to terminate image capture based on a determination that a sufficient amount of images are obtained to generate the 3-D scene.

19. The scene reconstruction system of claim 12 wherein the central entity broadcasts the message to terminate image capture based on a determination a predetermined number of images is captured.

20. The scene reconstruction system of claim 12 wherein the central entity broadcasts the message to terminate image capture based on a determination no stationary vehicles are present at the scene of the event.
